(19) United States
(12) Patent Application Publication
(10) Pub. No.: US 2006/0109452 A1
(43) Pub. Date: May 25, 2006

(54) Device and method for chromatic dispersion measurement

(76) Inventor: Eberhard Loecklin, Reutlingen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/286,294

(22) Filed: Nov. 23, 2005

(30) Foreign Application Priority Data
Nov. 23, 2004 (EP) EP 04027725.3

(51) Int. Cl. G01N 21/00

(52) U.S. Cl. 356/73.1

(57) ABSTRACT

In a method for measuring the chromatic dispersion of an optical transmission line, preferably of an optical fiber, an amplitude-modulated optical signal is fed into the optical transmission line to be measured, the transmitted signal is split in an imaging dispersive optical means into several spatially separated partial spectra which are each detected by a photo detector of a photo detector arrangement. Phase differences are determined from the detected signals in an evaluation circuit, from which the chromatic dispersion of the optical transmission line is determined.

### CROSS REFERENCE TO RELATED APPLICATIONS

This application claims priority under 35 U.S.C. §119(a) to European Patent Application No. 04 027 725.3, filed Nov. 23, 2004, the entire contents of which are hereby incorporated by reference.

### FIELD OF THE INVENTION

The invention relates to a method and a device for measuring the chromatic dispersion of an optical transmission line.

### BACKGROUND OF THE INVENTION

Due to chromatic dispersion, light of different wavelengths passes through an optical transmission line, in particular, a glass fiber, at different speeds. If light of a broad optical spectrum is amplitude-modulated and individual partial spectra thereof are detected after passage through the glass fiber line, they phase positions of the modulation signal vary in each of the individual partial spectra. The amount of the chromatic dispersion can be determined from the wavelength and phase difference of the individual partial spectra.

Most of the conventional measuring methods (“modulation phase-shift method”, “differential phase-shift method”) are based on the classical Nyquist method for group delay time measurement. The optical carrier signal is amplitude-modulated with a frequency ω which is small compared to the carrier frequency. The optical frequencies are at approximately 200 THz in the 1550 nm range. This requirement is therefore met for modulation frequencies up to the high GHz range. The modulation frequency is retrieved at the end of the examination through demodulation and its phasing is compared to that of the modulation source.

The group delay t_{g} is used as a measure for the delay of a signal component, which is calculated as t_{g}=Δβ/ω according to Nyquist. The differentiation of the group delay t_{g} with respect to the wavelength λ related to the length L of the fiber is called the chromatic dispersion coefficient D: D=1/L*dt_{g}/dλ. To determine the chromatic dispersion in this measuring method, the group delay is determined in dependence of the wavelength, and then the differentiation of the group delay with respect to the wavelength is calculated.

A method and device of this type are disclosed e.g. in EP-A-1 233 256. In the method disclosed in EP-A-1 233 256, a spectrum is selected from the light which has passed through the optical transmission line. The spectrum passes through a first filter to obtain a reference signal, and through a second filter which can be continuously tuned, to obtain a measurement signal. The chromatic dispersion can be determined from the phase difference variations at different optical frequencies which are adjusted via the adjustable optical filter, as described above.

In practice, often only a few discrete wavelengths are used with the result that the chromatic dispersion is only approximately determined. The required number of measurement wavelengths and their mutual separation depend on the test sample. Relatively large wavelength steps of approximately 5 or 10 nm are sufficient for glass fibers. Narrow-band test samples such as e.g. dispersion compensators with Chirped Fiber Bragg Gratings require shorter steps (e.g. 0.5 nm).

It is the object of the present invention to further develop a method and a device of the above-mentioned type in such a manner that the chromatic dispersion can be measured with a simplified optical arrangement.

### SUMMARY OF THE INVENTION

This object is achieved by a method for measuring the chromatic dispersion of an optical transmission line, preferably of an optical fiber, wherein an amplitude-modulated optical signal is fed into the optical transmission line to be measured, wherein the transferred signal is split in an imaging dispersive optical means into several spatially separated partial spectra which are each detected by a photo detector of a photo detector arrangement, wherein in an evaluation circuit, the phase differences are determined from the detected signals, from which the chromatic dispersion of the optical transmission line is determined.

The inventive method for measuring the chromatic dispersion can be performed without a tuneable filter, which simplifies the structure of a measuring arrangement for performing the method, since movable parts can be omitted. The dispersive imaging optical means, e.g. an imaging grating, generates a spatial spectral decomposition of the transmitted optical signal in dependence of the wavelength. Each of the photo detectors therefore detects a partial spectrum of the transmitted signal of a defined wavelength.

In a preferred variant of the method, one of the photo detectors used as reference detector is rigidly connected to a phase meter of the evaluation circuit. A respective further photo detector is connected to the phase meter to determine a phase difference. The method can be performed in this case analogously to EP-A-1 233 256, wherein the photo detector which is rigidly connected to the phase meter serves as reference path and the further photo detectors serve as measuring paths of a predetermined wavelength.

In a further advantageous variant, a first and a second photo detector of the photo detector configuration are each connected to a phase meter of the evaluation circuit to determine a phase difference. In this case, it is possible to measure the phase between any two photo detectors of the photo detector configuration instead of the phase between a reference detector and a further photo detector.

In an alternative variant of the method, all photo detectors are rigidly connected to a multiplexer, and the signals of the photo detectors are read-out with a predetermined scanning frequency. This variant is particularly advantageous when a multitude of photo detectors are used.

In a further development of this variant, the scanning frequency of the multiplexer is phase-locked to the modulation frequency of the detected signal of a photo detector of the photo detector arrangement, which serves as reference detector. This particularly facilitates determination of the chromatic dispersion, since the signals detected by the photo detectors are time-invariant.

In an alternative further development, the scanning frequency and the modulation frequency are slightly different. In this further development, the detected signal at a photo detector is not temporally constant with the result that a maximum as well as a minimum of the transferred signal reaches each of the photo detectors, which permits scale calibration.

In a particularly preferred variant of the method, for calibration, the optical power of the detected signals of the photo detectors of the photo detector arrangement is measured for a period which is long compared to the period of the modulation frequency providing an average value of the optical power. All further measurements can be related to this average value.

The object is also achieved with a device for measuring the chromatic dispersion of an optical transmission line, preferably, of an optical fiber, in particular for performing the above-described method, comprising an amplitude-modulated, broad-band light source on the input side of the optical transmission line to be measured, an imaging dispersive optical means for splitting the transferred signals into several spatially separated partial spectra, a plurality of photo detectors in a photo detector arrangement for detecting one of the partial spectra each, and an evaluation circuit for determining the phase differences present between the partial spectra, from which the chromatic dispersion of the optical transmission line can be determined. The device is robust and can be constructed to be small, e.g. in a handheld.

In a preferred embodiment, a phase meter of the evaluation circuit is rigidly connected to a photo detector which serves as reference detector, and is connected to the further photo detectors of the photo detector arrangement via a multiplexer for connecting a respective of the further photo detectors to the phase meter. This construction is particularly advantageous when a small number of photo detectors are used.

In an alternative embodiment, a phase meter of the evaluation circuit is connected to the photo detectors of the photo detector arrangement via a first and a second multiplexer to connect a first and a second photo detector of the photo detector arrangement to the phase meter. In this case, it is possible to measure the phase difference not only between the reference detector and any further photo detector, but also directly between any two photo detectors of the photo detector arrangement.

In a further alternative embodiment, the phase meter comprises a multiplexer which is connected to the photo detectors of the photo detector arrangement, an electronic control means for evaluating the signals of the multiplexer and a clock generator which presets the scanning frequency of the multiplexer. This construction is advantageous when a major number of photo detectors are used, wherein e.g. CCD arrays may be used as multiplexers.

In a preferred embodiment, the photo detectors are designed as photo diodes and are disposed as photo detector arrangement in a diode line.

In a further preferred embodiment, the imaging dispersive optical means is formed by a grating, a prism or an arrayed waveguide grating.

Further advantages of the invention can be extracted from the description and the drawing. The features mentioned above and below may be used in accordance with the invention either individually or collectively in arbitrary combination. The embodiments shown and described are not to be understood as exhaustive enumeration but have exemplary character for describing the invention.

### BRIEF DESCRIPTION OF THE INVENTION

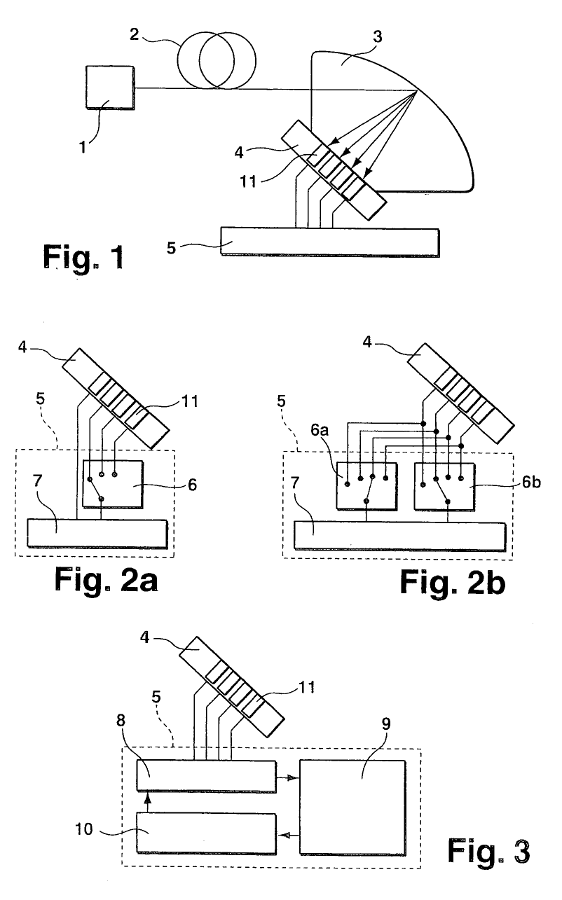

FIG. 1 shows the inventive device for measuring the chromatic dispersion of an optical transmission line;

FIG. 2 shows two partial views a, b of a first and a second embodiment of an evaluation circuit with a phase meter and one or two multiplexers for sequential measurement of partial spectra of a transferred optical signal;

FIG. 3 shows a third embodiment of the evaluation circuit for parallel measurement of partial spectra;

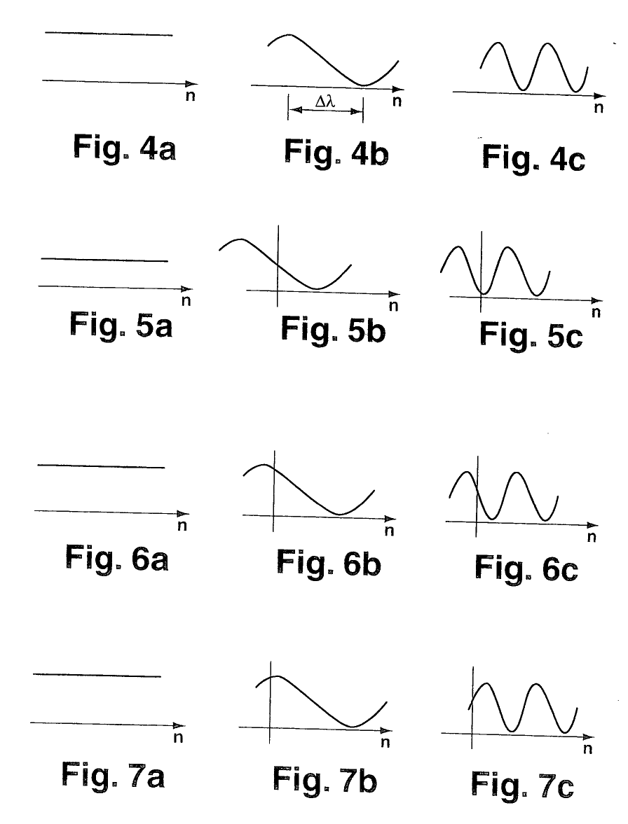

FIG. 4 shows three partial views a-c of a representation of a stationary spectrum of the transferred optical signal in dependence of the wavelength without, with low and with high chromatic dispersion;

FIG. 5 shows three partial views a-c of a representation of a spectrum of the transferred optical signal in dependence of the wavelength without, with low and high chromatic dispersion at a first point of time;

FIG. 6 shows three partial views a-c of a representation of the spectrum at a second point of time; and

FIG. 7 shows three partial views a-c of a representation of the spectrum at a third point of time.

### DESCRIPTION OF THE PREFERRED EMBODIMENT

FIG. 1 schematically shows the inventive device for measuring the chromatic dispersion of an optical transmission line. A light source 1 emits light with a broad-band optical spectrum which is amplitude-modulated with a modulation frequency ω. When the light has passed through the optical fiber 2 to be measured, it is decomposed in an imaging dispersive means 3 which is designed as grating spectrometer, into partial spectra which are detected by a photo detector arrangement 4 designed as diode line. The photo detector arrangement 4 is rigidly connected to an electronic evaluation circuit 5 for evaluating the phase differences between the partial spectra.

The phase differences may be measured analogously to the method described in EP-A-1 233 256, wherein two photo detectors of the photo detector arrangement 4 each provide input signals for a phase meter 7 (shown in FIG. 2a) of the evaluation circuit 5 for measuring a phase difference. A photo detector of the photo diode line 4, which serves as reference detector, is permanently connected to an input of the phase meter 7, while a second input of the phase meter 7 can be connected to one of the further photo detectors via a multiplexer 6. The tuning of the optical frequency of the second filter of EP-A-1 233 256 corresponds to switching the further photo detectors of the photo diode line 4. For calculation of the chromatic dispersion from the phase differences, reference is made to the description thereof.

In an alternative manner, the evaluation means 5 may also be designed as shown in FIG. 2b. In contrast to FIG. 2a, two multiplexers 6a, 6b are thereby connected to the photo detectors of the photo detector arrangement 4 and the phase meter 7. Each multiplexer 6a, 6b connects one of the photo detectors to the phase meter 7 which permits direct measurement of phase differences between any two photo detectors of the photo detector arrangement 4.

If the number of diodes of the photo detector configuration 4 is higher, the use of an evaluation circuit 5 having the construction as shown in detail in FIG. 3 is preferred. The evaluation circuit 5 comprises a multiplexer 8 with incorporated sample and hold circuits, which is rigidly connected to all photo detectors of the photo detector arrangement 4. The data of the multiplexer 8 is serially transmitted via an A/D converter (not shown), which is preferably part of the multiplexer 8, to an electronic control means 9 which controls a pulse generator 10 which controls the scanning frequency of the multiplexer 8.

The arrangement of FIG. 3 can either be operated with a synchronous or asynchronous method as described below, to determine the chromatic dispersion. In both methods, for calibrating the device, the optical power of the photo detectors of the photo detector arrangement 4 is initially measured with an averaging period which is long compared to the period of the modulation frequency of amplitude modulation. The average value of the detected optical power is thereby determined for each photo detector. All further measurements are related to this average value. In both method variants, the signals of the photo detectors are scanned with the sample and hold circuits of the multiplexer 8 during the actual measurement.

In the synchronous method variant, the scanning frequency is synchronized with locked phase relative to the modulation signal of one of the photo detectors via the electronic control unit 9. This photo detector is designated as reference detector 11 and the associated wavelength is designated as reference wavelength below.

If no chromatic dispersion occurs, all partial spectra are in phase. After correction using the above-mentioned average value, one obtains a detected signal which has the same value as the signal of the reference detector 11 for all photo detectors irrespective of the number n of an individual photo detector or of the wavelength λₙ associated with this number as shown in FIG. 4a. The detected signal is shown as continuous due to the large number of photo detectors.

In an optical fiber with chromatic dispersion, the modulation signal arrives at the individual photo detectors with different phases. While the signal at one of the photo detectors is in phase with the scanning frequency, i.e. provides a maximum signal, the signal at the next photo detector is slightly shifted, providing a smaller signal. For a linear phase shift over the wavelength, a sine curve over the wavelength is obtained having a period (in nm) which is smaller the larger the dispersion. Analogous to FIG. 4a, FIG. 4b shows the detected optical power in dependence of the wavelength with low chromatic dispersion and in FIG. 4c with high chromatic dispersion.

In the simplest evaluation of the synchronous method variant, the separation Δλ between a maximum and the subsequent minimum of the optical power is determined. The known associated phase difference ΔΦ=π is inserted into the formula for the group delay distortion: DGD=ΔΦ/ω*1/Δλ.

In the synchronous method variant, the signals shown in FIGS. 4a-c are time-invariant, i.e. each of the photo detectors is associated with a constant value of the optical performance. In the asynchronous method variant, the scanning frequency is shifted by a small amount compared to the modulation frequency ω, such that the phase between scanning signal and modulation signal slowly changes. Since the phase of the scanning signal varies with time relative to the modulation signal, the maximum of the optical performance also migrates from one photo detector to the next. Depending on the phase difference between the scanning frequency and the modulation frequency, the signal at the photo detectors will be larger or smaller. If no chromatic dispersion occurs, all partial spectra are in phase. After correction using the above-mentioned average value, one obtains again a signal which has the same value for all photo detectors irrespective of the number n of the individual photo detector or of the wavelength λₙ associated with this number. However, this signal varies with time with the difference frequency between scanning and modulation frequencies. FIG. 5a shows a constant value over the number n of photo detectors. At a first subsequent time instant, one obtains an identical value shown in FIG. 6a and at a second time instant also an identical value shown in FIG. 7a, etc.

In an optical fiber with chromatic dispersion, the modulation signal has different phases at the individual photo detectors. While it is in phase with the scanning cycle at one photo detector, i.e. provides a maximum signal, it is slightly shifted at the next photo detector, providing a smaller signal. Instead of a constant value, one obtains the curve of FIG. 5b for low chromatic dispersion and the curve of FIG. 5c for high chromatic dispersion. At a first, later instant of time, one obtains the curves of FIG. 6b and FIG. 6c and at a later, second point of time one obtains the curves shown in FIGS. 7b and 7c. The drawing shows in each case a vertical line for a fixed detector number to illustrate the shift of the signals over time.

In the simplest case, the wavelength separation Δλ between a maximum and minimum is determined to detect the chromatic dispersion like in the synchronous method variant. This corresponds to a phase shift of ΔΦ=π at the associated photo detectors. The group delay distortion can be calculated therefrom as in the synchronous case as DGD=ΔΦ/ω*1/Δλ.

The phase shift ΔΦ between two photo detectors at a separation Δλ can also be detected using a more complex algorithm, e.g. from the time difference between the occurrence of the maxima at both detectors. The asynchronous method variant is advantageous in that there is a maximum and a minimum at each photo detector over time, which permits calibrating of the scale.

The devices shown in FIGS. 1 through 3 are designed in miniaturized size as handheld.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

I claim:

1. A method for measuring the chromatic dispersion of an optical transmission line comprising the steps of:
inputting an amplitude-modulated optical signal into the optical transmission line;
splitting the amplitude-modulated optical signal in an imaging dispersive optical means into a plurality of spatially separated partial spectra which are each detected by a photo detector of a photo detector arrangement;
determining a phase difference from a plurality of detected signals in an evaluation circuit, from which the chromatic dispersion of the optical transmission line.

2. A method according to claim 1, wherein the step of determining a phase difference comprises connecting a first and a second photo detector of the photo detector arrangement to a phase meter of the evaluation circuit.

3. A method according to claim 1, wherein one of the photo detectors of the photo detector arrangement is a reference detector and connected to a phase meter of the evaluation circuit, and a second photo detector of the photo detector arrangement is connected to a phase meter for determination of the phase difference.

4. A method according to claim 1, wherein the method includes the step of connecting the plurality of photo detectors of the photo detector arrangement to a multiplexer and outputting the signals of the photo detectors of the photo detector arrangement with a predetermined scanning frequency.

5. A method according to claim 4, wherein the method includes the step of coupling the scanning frequency of the multiplexer with a locked phase to a modulation frequency of the detected signal of a photo detector of the photo detector arrangement, which serves as the reference detector.

6. A method according to claim 4, characterized in that the scanning frequency and the modulation frequency are different.

7. A method according to claim 1, wherein the method includes the step of calibrating an average value of optical performance by measuring an optical performance of the detected signals of the photo detectors of the photo detector arrangement for a long period compared to the period of the modulation frequency.

8. A device for measuring the chromatic dispersion of an optical transmission line comprising:
an amplitude-modulated broad-band light source positioned on the input side of the optical transmission line, and which generates an amplitude-modulated signal that is inputted into the optical transmission line;
an imaging dispersive optical means for splitting the amplitude-modulated broad-band light signal into a plurality of spatially separated partial spectra;
a plurality of photo detectors in a photo detector configuration, each one of the plurality of photo detectors detects one of the plurality of spatially separated partial spectra; and
an evaluation circuit for determining the phase differences between the partial spectra, from which the chromatic dispersion of the optical transmission line can be determined.

9. The device according to claim 8, wherein a phase meter of the evaluation circuit is rigidly connected to a photo detector which serves as reference detector, and is connected to the further photo detectors of the photo detector arrangement via a multiplexer for connecting one of the plurality of photo detectors of the photo detector arrangement to the phase meter.

10. The device according to claim 8, wherein a phase meter of the evaluation circuit is connected to the photo detectors of the photo detector arrangement via a first and a second multiplexer for connecting a first and a second photo detector of the photo detector configuration to the phase meter.

11. The device according to claim 8, wherein the evaluation circuit comprises a multiplexer which is connected to the photo detectors of the photo detector arrangement, an electronic control means for evaluating the signals of the multiplexer and a clock generator for presetting the scanning frequency of the multiplexer.

12. The device according to claim 8, wherein the photo detectors are designed as photo diodes and are disposed in a diode line as photo detector arrangement.

13. The device according to claim 8, wherein the imaging dispersive optical means is formed by a grating, a prism, or an arrayed waveguide grating.

14. A device for measuring the chromatic dispersion of an optical transmission line comprising:
an amplitude-modulated broad-band light source positioned on the input side of the optical transmission line to be measured;
a amplitude-modulated signal generated by the amplitude-modulated broad-band light source;
an imaging dispersive optical means for splitting the transmitted amplitude-modulated signal into a plurality of spatially separated partial spectra; and
an evaluation circuit for determining the phase differences between the partial spectra, from which the chromatic dispersion of the optical transmission line can be determined.
